(19) United States
(12) Patent Application Publication
(10) Pub. No.: US 2003/0006575 A1
(43) Pub. Date: Jan. 9, 2003

(54) Side impact friendly running board

(76) Inventors: Shane Genis, Victoria Harbor (CA); Mike Gracey, Huntsville (CA); Ross Bradsen, Huntsville (CA); Paul Bannerman, Huntsville (CA); Nathan Keith, Huntsville (CA); Judy Smith, Huntsville (CA); Patrick Caricato, Huntsville (CA); Gerrit Hoekstra, Huntsville (CA); Ulrich Stegelmeier, Bracebridge (CA); Rick Smith, Huntsville (CA); Shawn Wale, Orillia (CA); Graeme Hourie, Huntsville (CA); David Hourie, Huntsville (CA); Robert Kiernan, Huntsville (CA); Alana Cates, Dorset (CA); Steve Gregory, Huntsville (CA); Patrick Duncan, Nobel (CA); Bob Greer, Baysville (CA)

Correspondence Address: HARNESS, DICKEY & PIERCE, P.L.C., P.O. BOX 828, BLOOMFIELD HILLS, MI, 48303, US

(21) Appl. No.: 10/141,543

(22) Filed: May 8, 2002

Related U.S. Application Data
(60) Provisional application No. 60/289,487, filed on May 8, 2001.

(51) Int. Cl. B60R 3/00

(52) U.S. Cl. 280/163

(57) ABSTRACT

A running board assembly is designed such that it does not adversely effect the triggering properties of a side-impact airbag system. In a first embodiment, upon incurring an impact, the running board moves to a position inward of the side of the vehicle at a controlled collapsing load. The controlled collapsing load does not adversely effect the trigger point at which a side-impact airbag system must not deploy nor does it adversely effect the trigger point at which a side-impact airbag system must deploy. In a second embodiment, the structure of the running board assembly is designed to transfer a side-impact load directly to the vehicle's side-impact airbag system.

### CROSS-REFERENCE TO RELATED APPLICATIONS

This application claims the benefit of U.S. Provisional Application No. 60/289,487, filed May 8, 2001.

### FIELD OF THE INVENTION

The present invention relates to running boards. More particularly, the present invention relates to running board systems that minimize the effects on side impact air bag triggering characteristics and that consider other side impact safety factors.

### BACKGROUND OF THE INVENTION

Airbag systems for vehicles have been installed on passenger cars and trucks for several years. In the airbag systems for today's vehicles, an inflatable airbag is contained in a folded condition in a center pad of a steering wheel or in a compartment in the instrument panel. The deployment of the airbag is controlled by sensors that determine if a head-on collision of some sort has occurred. Once deployed, the body of an occupant in the vehicle is caught by the airbag that is inflated instantaneously by a gas such as compressed air or an explosion. The airbag serves to absorb the forward force of inertia that acts on the occupant of the vehicle and prevents the occupant from impacting the steering wheel, the instrument panel, or the like. These airbag systems have proven effective during head-on collisions, but they do not deploy themselves during side-impact collisions for various reasons.

In order to protect an occupant of a vehicle during a side-impact, side-impact airbag systems have been developed. In the side-impact airbag systems, an airbag is contained in a folded condition in a compartment in a seat or in a compartment in a side face of the interior trim of the vehicle, such as the inside trim of the vehicle's door. The deployment of the side-impact airbag is controlled by sensors that determine if a side-impact collision of some sort has occurred. Once deployed, the body of an occupant in the vehicle is caught by the airbag that is inflated instantaneously by a gas such as compressed air or an explosion. The side-impact airbag serves to absorb the lateral force of inertia that acts on the occupant of the vehicle and prevents the occupant from impacting the inside of the door or the like.

The sensors that are used for the deployment of the airbags are typically some type of sensing devices which are capable of detecting the force of impact on a vehicle. For example, the sensor for a front airbag system will not typically deploy the airbag unless the head-on collision exceeds a predetermined value. The predetermined value is sometimes expressed as a mile-per-hour impact, such as the force of an impact that exceeds a fifteen miles-per-hour collision. The sensor for a side-impact airbag system is also calibrated to not deploy the airbag until a specific side-impact force is realized.

Because of this sensing for a minimal impact before deploying the airbags, it is necessary that any equipment which has been added to the vehicle must not have any effect or it must remain friendly to the airbag system in general and to the side-impact airbag system in particular. The side-impact airbag systems are relatively new to the automotive industry and thus the effects of add-on equipment or optional equipment on these systems has not been fully investigated. With the increasing number of side-impact airbag systems being developed in the automotive industry, it is now a requirement to develop add-on or optional equipment which have little, if any, effect on the proper operation of these systems.

### SUMMARY OF THE INVENTION

The present invention provides the art with a design for a side running board which has minimal effect or is friendly to the side-impact airbag systems being developed. The running board of the present invention is designed as either an energy absorbing (deformable) beam (or structure) or as an energy transferring (rigid) beam (or structure) when subjected to a lateral impact. In the energy absorbing structure, deformable members such as the support brackets for the running board are designed to deform or break away in such a way that the running board is deflected underneath or sideways and underneath the vehicle. This deflection or deformation of the running board has minimal effect on the side-impact airbag system. In the energy transferring structure, the running board and its associated mounting structure are designed to transfer the side impact energy to a component of the automobile that is part of the vehicle's system which operate the side impact air bag system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partial perspective view of a vehicle equipped with a running board system in accordance with the present invention;

FIG. 2 is a perspective view of the brackets which are part of the running board system shown in FIG. 1;

FIG. 3 is a side view of one of the brackets for the running board shown in FIGS. 1 and 2 with the bracket in its normal condition; and

FIG. 4 is a side view of the bracket shown in FIG. 3 with the bracket in its collapsed condition;

FIG. 5 is a schematic view of a running board assembly in accordance with another embodiment of the present invention;

FIG. 6 is a schematic view of a running board assembly in accordance with another embodiment of the present invention;

FIG. 7 is a schematic view of a running board assembly in accordance with another embodiment of the present invention;

FIG. 8A is a schematic view of a running board assembly in accordance with another embodiment of the present invention;

FIG. 8B is a schematic view of a running board assembly in accordance with another embodiment of the present invention;

FIGS. 8C is a schematic view of a running board assembly in accordance with another embodiment of the present invention;

FIG. 8D is a schematic view of a running board assembly in accordance with another embodiment of the present invention;

FIG. 9 is a schematic view of a running board assembly in accordance with another embodiment of the present invention;

FIG. 10A is a schematic view of a running board assembly in accordance with another embodiment of the present invention with the running board in an extended position; and

FIG. 10B is a schematic view of the running board assembly in FIG. 10 in a retracted position.

### DETAILED DESCRIPTION OF THE PREFERRED EMBODIMENTS

The following description of the preferred embodiment(s) is merely exemplary in nature and is in no way intended to limit the invention, its application, or uses.

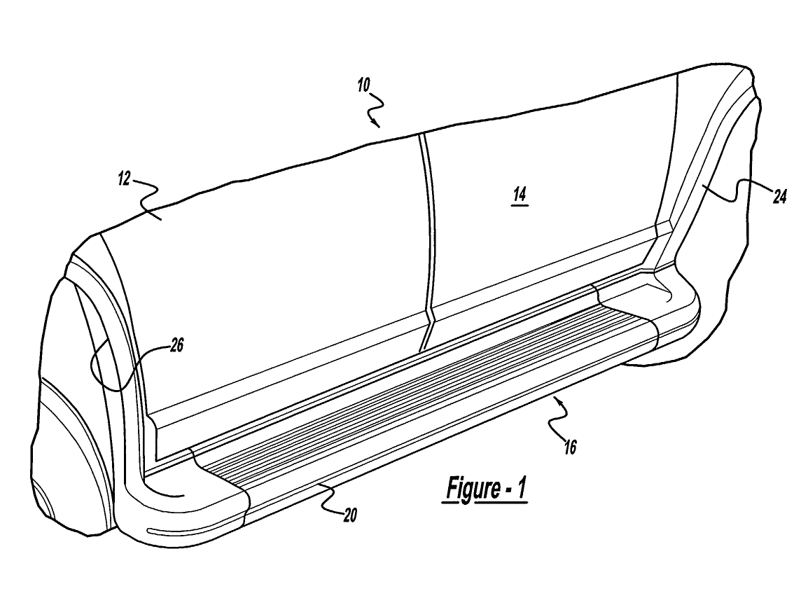

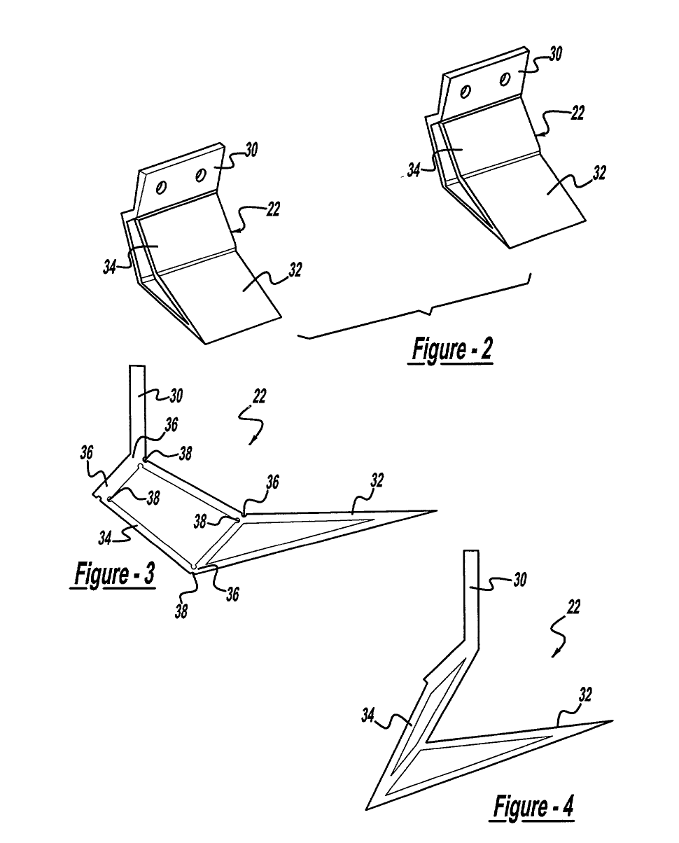

Referring now to the drawings in which like reference numerals designate like or corresponding parts throughout the several views, there is shown in FIG. 1 a vehicle having a side running board in accordance with the present invention and which is designated generally by the reference numeral 10. Vehicle 10 includes a body 12 having a door 14 and a running board assembly 16. Vehicle 10 is equipped with a side-impact airbag system (not shown) for the protection of the occupants of the vehicle. Running board assembly 16 comprises a running board 20 and a pair of brackets 22 (see FIG. 2). Brackets 22 are secured to a structural member of vehicle 10 and they support running board 20 immediately below the level of door 14. Typically, running board 20 is designed such that it extends between a front wheel well 24 and a rear wheel well 26 of vehicle 10. Brackets 22 are attached to the structural member of vehicle 10 and running board 20 is attached to brackets 22 by methods known well in the art.

Referring now to FIG. 3, each bracket 22 comprises a generally vertical attachment section 30, a load supporting section 32 and a controlled deformation section 34. Attachment section 30 is designed to mate with and attach to the appropriate structure of vehicle 10. This structure can be the vehicle's frame, the vehicle's uni-body construction or any other structure capable of supporting the required load. Load supporting section 32 extends generally perpendicular to attachment section 30 and is designed to support running board 20 such that running board 20 is generally horizontally positioned with respect to the vehicle.

Controlled deformation section 34 is a generally trapezoidal shaped section defining four corners 36. Each corner 36 defines one or preferably two bend corners or notches 38. Each bend corner or notch 38 is designed to yield at a specific load such that upon impact, each bracket 22 compresses from a normal position as shown in FIG. 3 to a compressed position as shown in FIG. 4. As each bracket 22 moves to its compressed position as shown in FIG. 4, running board 20 moves to a position underneath vehicle 10 to minimize any effect on the side-impact airbag system incorporated into vehicle 10. Thus, running board assembly 16 allows lateral energy absorption due to the collapsing of brackets 22 and the collapsing of brackets 22 cause both brackets 22 and running board 20 to move to a position underneath vehicle 10 in order to have minimal effect on the trigger points of the side-impact airbag system.

The minimal effect is critical to the safety of the vehicle's occupants. The purpose of the side-impact airbag system is to cushion the head and upper body from a rapidly accelerating window/door/B-pillar during the critical milliseconds after initial impact. Automotive manufacturers and other jurisdictions are developing safety standard tests that are measured under strictly controlled conditions.

There is an industry consensus that there should be some “tolerance window” within which deployment may or may not be triggered depending upon where in this “tolerance window” the particular system is manufactured. A typical airbag system deployment criteria is that they must NOT be triggered in an impact at fifteen miles per hour or less and that they MUST be triggered in an impact of thirty miles per hour or more. This provides a window, between fifteen and thirty miles per hour where the triggering mechanism MAY or MAY NOT be activated. This window is allowed in order to compensate for system tolerances, variations in crash conditions and variations in environmental conditions.

By accessorizing the vehicle with a running board/step assist device, a person has the potential to effect the triggering mechanism of the airbag system. On the other hand, an added running board system may trigger the airbag system earlier than designed or it may trigger the airbag system later than designed. If the running board system is designed overly rigid, the impact energy could be quickly transferred to vehicle 10 by virtue of the position of brackets 22 or proximity of running board 20 to vehicle 10. On the other hand, if the running board system is designed to have considerable energy absorbing properties, the deployment time could be slowed down too far. In either case, there is a potential for unintended injury. Only if the running board system is designed to effect the system triggering within the “may or may not trigger window” discussed above, can the running board system be assumed “deployment neutral” or “friendly” to the triggering requirement. Running board assembly 16 with brackets 22 and the controlled collapsing of brackets 22 is designed to fall within this window.

If we assume that side-impact airbags are not fitted on vehicle 10, then in a majority of the cases, the addition of a running board/step assist device will act like a supplementary rigid beam several inches out from the vehicle. Conceptually, this rigid beam will act to protect the occupants from intrusion of the impacting vehicle. The running board/step assist device may also absorb considerable more energy and thus slow the impacting vehicle down to a degree that may actually reduce injury or death. A longer, more rigid running board is more likely to spread the impact energy across a wider swath of the vehicle, acting like a side impact door beam, thus reducing intrusion. Thus, this design of running board would be a net safety contributor. However, these safety properties do not necessarily ensure safe airbag deployment as detailed above. Thus, a collapsible running board is one option that may be provided in order to be compatible with side-impact airbag systems.

During collapsing of the running board, whether it is a longer, more rigid design or is designed to be compatible with side-impact airbag systems, it is possible in a minority of cases for the running board/step assist device to act as a “knife edge” that actually concentrates the impact which may actually promote vehicle intrusion. Although improbable due to the low position of the running board relative to the higher position of the occupant, it is conceivable that an intruding beam may injure an occupant in the pelvic area and/or lower limbs, especially if the running board beam is deflected at some upward angle. As described above for running board assembly 16, brackets 22 are designed to deflect or compress such that running board 20 is directed to a position underneath vehicle 10. Thus, any intrusion of running board 20 into vehicle 10 is minimized or eliminated regardless of whether or not vehicle 10 is equipped with the side-impact airbag system.

Finally, when designing a running board/step assist system, consideration should be given to preventing the running board from detaching from the vehicle and becoming a projectile; to preventing the running board from penetrating the fuel tank and fuel lines; and to preventing the running board from creating a shower of sparks should it be thrust onto the roadway. In order to address these concerns, as well as the previously addressed concerns, running board assembly 16 is designed as an energy absorbing system rather than a rigid system due to collapsing brackets 22; brackets 22 are designed to move in a downward or downward-and-sideways motion to a position underneath vehicle 10; and both running board 20 and brackets 22 are manufactured from a nonferrous material, preferably aluminum, to reduce this potential to create sparks during an accident.

As stated above the accessorizing of the vehicle with a running board/step assist device should not significantly affect the window of deployment or triggering for the side-impact air bag systems being added to vehicles to cushion the head and upper body from impact. Running board assembly 16 discussed above is one embodiment of a collapsible running board assembly which addresses this issue. Detailed below are other solutions to this problem.

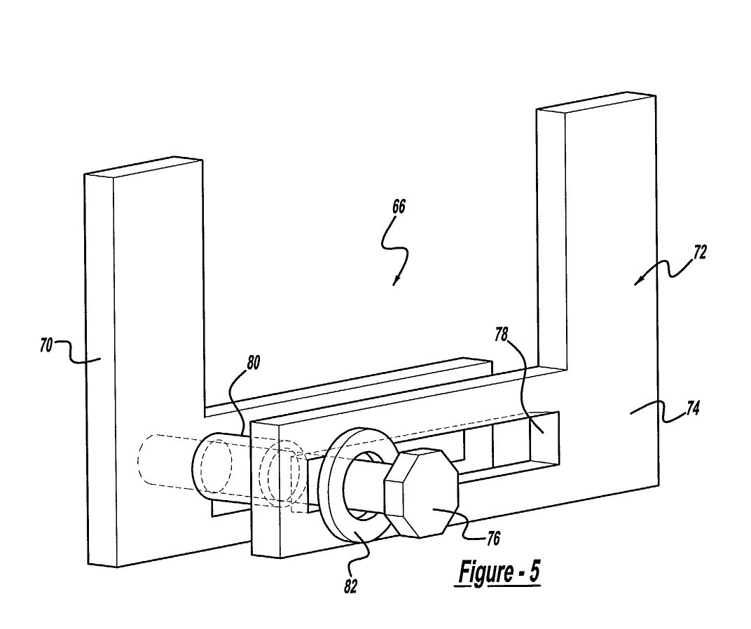

FIG. 5 is a schematic illustration of a running board assembly 66. Running board assembly 66 comprises a running board 70 and a pair of bracket assemblies 72 (only one shown in FIG. 5). Bracket assemblies 72 comprise a bracket 74 secured to a portion of the vehicle and mounting bolt 76 used to attach running board 70 to a respective bracket assembly 72. Bracket 74 defines a mounting slot 78. Bolt 76 extends through slot 78 and engages running board 70 to secure running board 70 to bracket 74. A washer or sleeve 80 is disposed between bracket 74 and running board 70 and a washer or sleeve 82 is disposed between bracket 74 and bolt 76. The incorporation of washers or sleeves 80 and 82 will prevent over tightening of the assembly and slot 78 will create a relief path for running board 70 to follow allowing it to collapse or move inward upon a side impact.

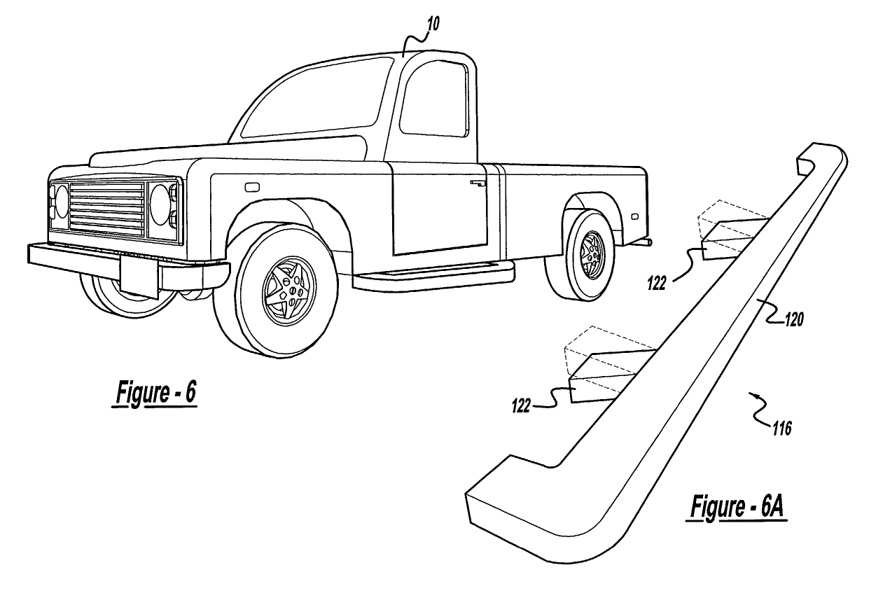

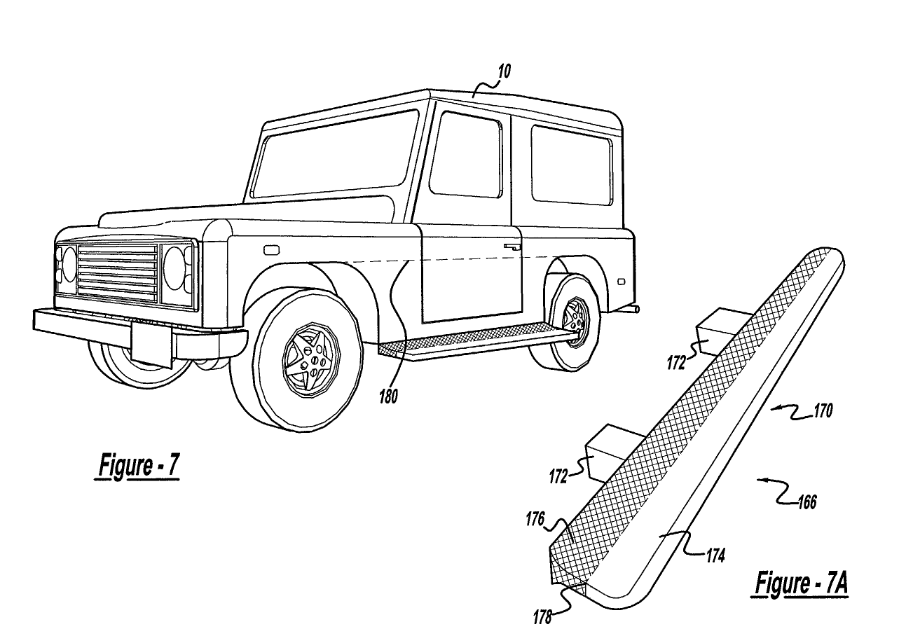

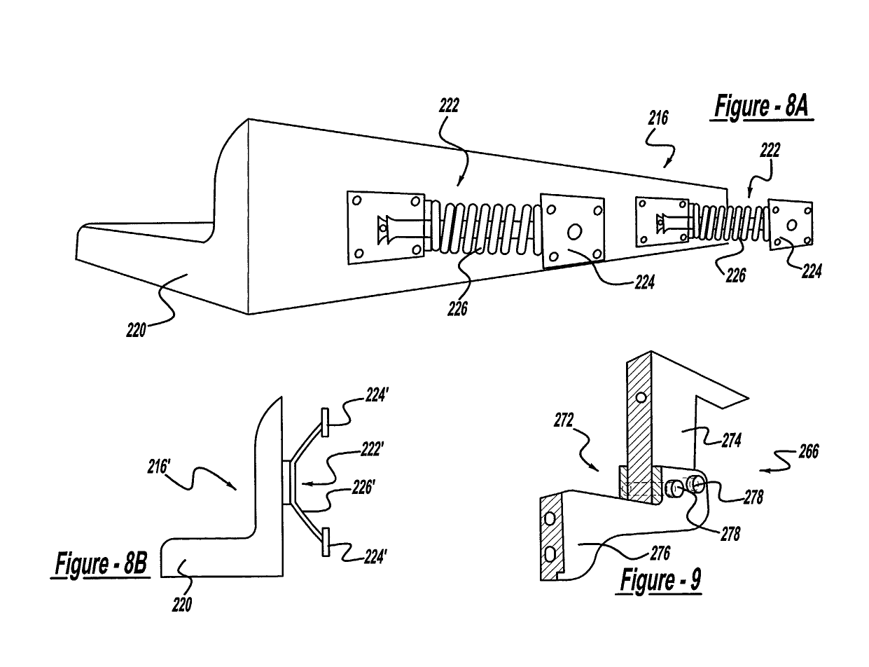

FIG. 6 is a schematic illustration of a running board assembly 116. Running board assembly 116 comprises a running board 120 and a pair of hinges or folding brackets 122. Brackets 122 in FIGS. 1-3 are designed to deform in a generally vertical direction to move running board 20 to a position under vehicle 10. Brackets 122 are attached to the structural member of vehicle 10 and running board 20 by methods known in the art. Brackets 122 are designed to angulate or hinge from an installed or straight position shown in solid in FIG. 6 to an angled position shown in phantom in FIG. 6 to angle running board 20 under vehicle 10. This angulation or hinging of bracket 122 is designed to be in a generally horizontal plane which causes running board 120 to “fold” side-ways when the force of impact is applied. The load necessary to angulate brackets 122 can be controlled to control the collapsing load for running board assembly 116. While brackets 122 are illustrated and described as angulating in a generally horizontal plane, it is within the scope of the present invention to have brackets 122 angulate in other planes including vertical if desired.

FIG. 7 is a schematic illustration of a running board assembly 166. Running board assembly 166 comprises a running board 170 and a pair of bracket 172. Brackets 172 are attached to the structural member of vehicle 10 and running board 170 by methods known in the art. During a side impact, brackets 172 are not designed to deflect. Instead, running board 170 is designed to deflect to provide the minimal effect or to be friendly with the side-impact air bag system. Running board 170 comprises a two part construction that includes a soft zone 174 and a solid zone 176. The parting line or plane 178 between zones 174 and 176 is designed to be co-planer with a plane 180 defined by the most external side point of vehicle 10 as illustrated in FIG. 7 or the place at which the impact is first transmitted (e.g., the door pillar or the door beam). Soft zone 1745 is manufactured from a foam/low density material which allows for rapid break-away during a side impact. Solid zone 176 is not designed to collapse on break away but because it is located inside the plane of the most external side point of vehicle 10. The side-impact airbag system will not be adversely affected by solid zone 176 during a side-impact.

FIG. 7 is illustrated with soft zone 174 manufactured from a foam/low density material. The material for soft zone 174 can include foamed aluminum, homey comb structures, rubber, foamed plastic, EPP (Expanded Polypropelene), EPS (Expanded Polystyrene), or other compliant energy absorbing materials. In addition, during the manufacture of soft zone 174, perforated holes where the size of the holes and the number of the holes can be utilized to control the collapsible characteristics of the running board. In addition, by varying the number of holes and/or the size of the holes for various applications, a tunable device can be manufactured for multiple applications with a minimal of tooling changes and a minimal amount of internal testing. When a corrugated material for soft zone 174 is selected, the angle of corrugation can also be varied to control the collapsing characteristics of the running board assembly. Finally, while running board 170 is illustrated as having soft zone 174 and solid zone 176, it is within the scope of the present invention to have running board 170 manufactured from only soft zone 174 thus eliminating solid zone 176. Also, this soft and hard zone concept can be designed into brackets 172, if required.

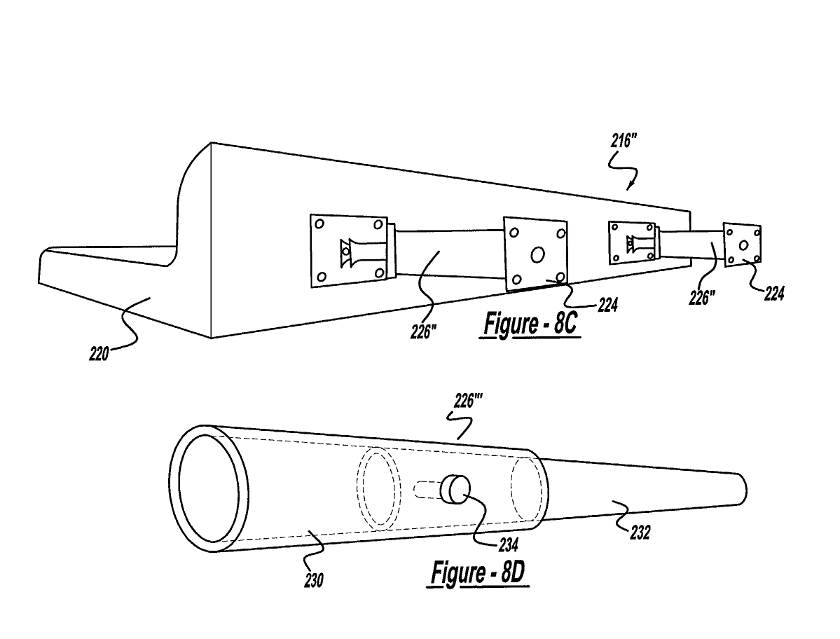

FIG. 8A is a schematic illustration of a running board assembly 216. Running board assembly 216 comprises a running board 220 and a pair of collapsible brackets 222. Brackets 222 are attached to the structural member of vehicle 10 and running board 220 by methods known in the art. Brackets 222 are designed to collapse axially due to an impact load. Each bracket 222 comprises a support member 224 and a coil spring mechanism 226. This axially collapsing of bracket 222 is designed to move running board 220 inward towards the vehicle to allow the major portion of the impact to reach vehicle 10 and trigger the side-impact airbag system. The load necessary to collapse brackets 222 can be controlled by coil spring selection to control the collapsing load for running board assembly 216. While brackets 222 are illustrated and described as collapsing in a generally horizontal plane, it is within the scope of the present invention to have brackets 222 be angulated with respect to the horizontal plane to control the collapsing plane for running board assembly 216.

FIG. 8B is a schematic illustration of a running board assembly 216′. Running board assembly 216′ is the same as running board assembly 216 except that bracket 222 has been replaced by bracket 222′. Bracket 222′ comprises a plurality of support members 224′ and a leaf spring 226′. The function and operation of running board assembly 216′ is the same as that described above for running board assembly 216.

FIG. 8C is a schematic illustration of a running board assembly 216″. Running board assembly 216″ is the same as running board assembly 216 except that coil spring mechanism 226 is replaced by a shock absorber 226″. Shock absorber 226″ is designed to operate in a similar manner to coil spring mechanism 226 to move running board 220 out of the way to allow the side impact of vehicle 10.

FIG. 8D is a schematic illustration of a collapsible tube assembly 226′″ which is designed to replace coil spring assembly 226 in running board assembly 216. Collapsible tube assembly 226′″ comprises an outer tube 230 and an inner tuber 232 telescopically received within outer tube 230. One or more shear pins 234 attach outer tube 230 with inner tube 232. Each shear pin 234 is designed with a specified shear strength in order to control the point at which collapsible tube assembly 226′″ will collapse allowing running board 220 to move inward and thus allowing the side impact of vehicle 10.

FIG. 9 is a schematic illustration of a running board assembly 266. Running board assembly 266 comprises running board 220 and a pair of bracket assemblies 272 (only one shown in FIG. 9). Bracket assemblies 272 are attached to the structural member of vehicle 10 and running board 220 by methods known in this art. Bracket assemblies 272 comprise an inner bracket 274 attached to the structural member of the vehicle and an outer bracket 276 attached to running board 220. One or more shear pins 278 attach bracket 274 to bracket 276. Each shear pin 278 is designed with a specified shear strength in order to control the point at which bracket assembly 272 will collapse allowing running board 220 to move inward and thus allowing the side impact of vehicle 10. While FIGS. 8D and 9 are described using shear pins designed with a specified shear strength, it is within the scope of the present invention to utilize brittle material for other structures for the brackets or other inserts for the brackets to control the collapsing of the brackets.

While FIG. 3 is illustrated having bend corners or notches 38, it is within the scope of the present invention to place notches in critical areas of any bracket and/or and running board in an attempt to control the collapsing of the running board assembly.

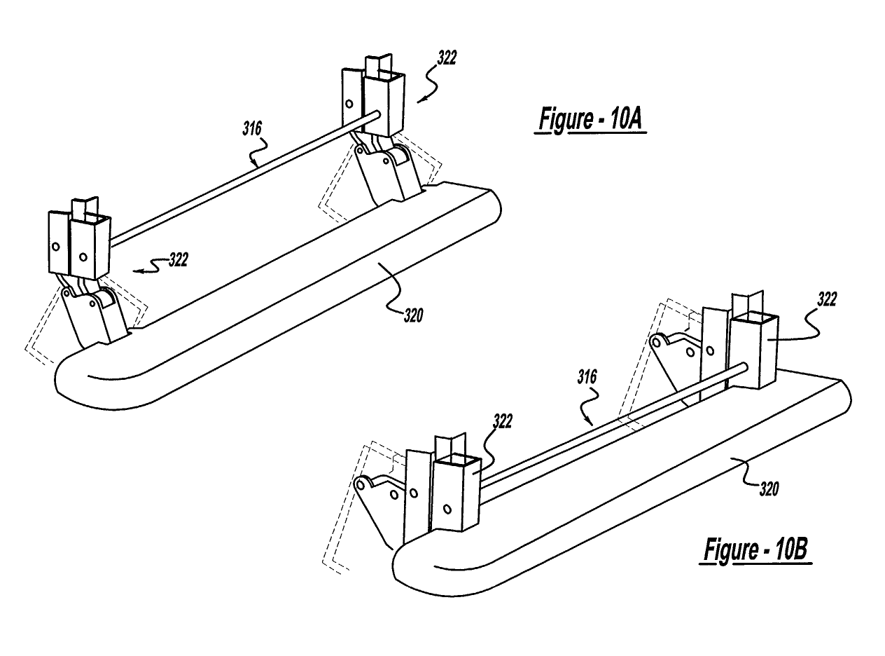

FIGS. 10A and 10B illustrate a running board assembly 316 which is of a retractable design. Running board assembly 316 comprises a running board 320 and a pair of retractable brackets 322. Brackets 322 are attached to the structural member of vehicle 10 and to running board 20 by methods known well in the art. Each bracket 322 is comprised of a four-bar linkage which moves running board 320 from an extended position shown in FIG. 10A to a retracted position as shown in FIG. 10B. The retracted position of running board 320 is designed to be inside the plane of the side of vehicle 10 thus allowing side impact directly to vehicle 10. The retraction of running board 320 can be automatically performed by the closing of a door of vehicle 10 or running board 320 can be designed to retract at a specified speed of vehicle 10. While the above designed for a retractable running board is illustrated as a four-bar linkage, it is within the scope of the present invention to utilize other designs for retractable running boards including but not limited to CD drawer designs, folding designs, rotating designs or other designs for retractive running boards.

The above described embodiments describe running board assemblies which are designed to collapse in order to allow the impact to reach the vehicle and activate the side-impact air bag systems. Another method of not significantly affecting the side-impact air bag systems is to have the impact on the running board assembly transferred directly to the vehicle and/or the side-impact air bag systems. One method of accomplishing this would be to provide a linkage member or a tie bar which is connected between the running board assembly and an accelerometer or the body of the vehicle to provide an adjustable mechanism to set off the air bags upon impact of the running board assembly.

Another method of transferring the impact of the running board assembly to the vehicle would be to attach the running board assembly directly to the frame or unibody of the vehicle. By attaching the running board assembly directly to the frame or unibody, the rigidity of the system will send the shock wave of the impact directly to the vehicle to trigger the air bag sensor immediately. In addition to attaching the running board assembly directly to the vehicle's frame or unibody, the running board assembly can be strengthened so that it will absorb very little energy and thus more effectively transfer the shock wave of the impact to the vehicle. This strengthened running board can also be utilized effectively when the running board assembly is not attached directly to a frame or unibody of a vehicle.

Finally, the concept of controlling the collapse of the running board in response to a side impact can be applied to running board systems which do not utilize any brackets. In these systems, the running board is attached directly to the side structure of the vehicle.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A running board assembly in combination with a vehicle, said running board assembly comprising:
a running board;
a bracket attached to said running board and attached to said vehicle, said bracket being movable from a first position where said running board is positioned outward of a plane defined by an external point of said vehicle to a second position where said running board is positioned inward of said plane.

2. The combination according to claim 1 wherein said bracket is movable from said first position to said second position due to an impact load.

3. The combination according to claim 2 wherein said bracket includes a controlled deformation section.

4. The combination according to claim 3 wherein said controlled deformation section is a generally trapezoidal shaped section.

5. The combination according to claim 3 wherein said bracket includes a load supporting section.

6. The combination according to claim 2 wherein said bracket defines a slot, said running board being secured to said bracket using said slot.

7. The combination according to claim 2 wherein said bracket comprises a hinge.

8. The combination according to claim 2 wherein said running board includes a soft zone, said soft zone being designed to collapse due to said impact load.

9. The combination according to claim 8 wherein said running board includes a solid zone, said solid zone being disposed adjacent said vehicle.

10. The combination according to claim 2 wherein said bracket includes a biasing member urging said running board into said first position.

11. The combination according to claim 10 wherein said biasing member is a coil spring.

12. The combination according to claim 10 wherein said biasing member is a leaf spring.

13. The combination according to claim 2 wherein said bracket includes a shock absorber.

14. The combination according to claim 2 wherein said bracket includes a first tube and a second tube, said second tube being telescopically received within said first tube.

15. The combination according to claim 14 further comprising a shear pin extending between said first and second tubes.

16. The combination according to claim 2 wherein said bracket includes an inner bracket attached to said vehicle and an outer bracket attached to said running board, said outer bracket being releasably secured to said inner bracket.

17. The combination according to claim 16 further comprising a shear pin extending between said outer and inner brackets.

18. The combination according to claim 1 wherein said bracket is movable from said first position to said second position due to a signal received from said vehicle.

19. The combination according to claim 18 wherein said signal is provided when a door of said vehicle is closed.

20. The combination according to claim 19 wherein said signal is provided when said vehicle reaches a specified speed.

21. A running board assembly in combination with a vehicle, said running board assembly comprising:
a running board, attached to said vehicle, said running board being movable from a first position where said running board is a positioned outward of a plane defined by an external point of said vehicle to a second position where said running board is positioned inward of said plane; and
an attachment member for attaching said running board to said vehicle.

22. The combination according to claim 21 wherein said running board is movable from said first position to said second position due to an impact load.

23. The combination according to claim 22 wherein said running board includes a controlled deformation section.

24. The combination according to claim 22 wherein said running board includes a soft zone, said soft zone being designed to collapse due to said impact load.

25. The combination according to claim 24 wherein said running board includes a solid zone, said solid zone being disposed adjacent said vehicle.
